(19) United States
(12) Patent Application Publication
(10) Pub. No.: US 2021/0287092 A1
(43) Pub. Date: Sep. 16, 2021

(54) METHOD AND DEVICE FOR PRUNING CONVOLUTIONAL LAYER IN NEURAL NETWORK

(71) Applicant: MONTAGE TECHNOLOGY CO., LTD., Shanghai (CN)

(72) Inventors: Yuanfei NIE, Shanghai (CN); Zhen DONG, Shanghai (CN); Huan FENG, Shanghai (CN)

(21) Appl. No.: 17/107,973

(22) Filed: Dec. 1, 2020

(30) Foreign Application Priority Data
Mar. 12, 2020 (CN) 202010171150.4

(51) Int. Cl. G06N 3/08; G06K 9/62

(52) U.S. Cl. CPC G06N 3/082; G06N 5/046; G06N 3/084; G06K 9/6202

(57) ABSTRACT

The present application discloses a method and a device for pruning one or more convolutional layer in a neural network. The method includes: obtaining one target convolution layer from the one or more convolution layers in the neural network, the target convolution layer including C filters, each filter including K convolution kernels, and each convolution kernel including M rows and N columns of weight values, where C, K, M and N are positive integers greater than or equal to one; determining a number P of weight values to be pruned for each convolution kernel of the target convolution layer based on a number of weight values M×N in the convolution kernel and a target compression ratio, where P is a positive integer smaller than M×N; and setting P weight values with the smallest absolute values in each convolution kernel of the target convolution layer to zero to form a pruned convolution layer.

### CROSS REFERENCE TO RELATED APPLICATIONS

This application claims priority to Chinese patent application No. 202010171150.4 filed on Mar. 12, 2020, the entire content of which is incorporated herein by reference.

### TECHNICAL FIELD

This application relates to the field of neural network, and in particular, to a method and a device for pruning a convolution layer in a neural network.

### BACKGROUND

Nowadays, deep learning has been widely used in many technical fields, such as image recognition, voice recognition, autonomous driving, and medical imaging. Convolutional neural network (CNN) is a representative network structure or algorithm in deep learning, and has achieved great success in the image processing application. However, the CNN model has too many parameters, and costs a large amount of storage and computing capabilities, limiting its application in other fields.

### SUMMARY

An object of this application is to provide a method for pruning one or more convolution layers in a neural network to improve the efficiency and accuracy of a pruning operation.

In an aspect of the application, a method for pruning one or more convolution layers in a neural network is provided. The method includes: obtaining one target convolution layer from the one or more convolution layers in the neural network, the target convolution layer including C filters each including K convolution kernels, and each of the K convolution kernels including M rows and N columns of weight values, where C, K, M and N are positive integers greater than or equal to one; determining a number P of weight values to be pruned for each convolution kernel of the target convolution layer based on a number of weight values M×N in the convolution kernel and a target compression ratio, where P is a positive integer smaller than M×N; and setting P weight values with the smallest absolute values in each convolution kernel of the target convolution layer to zero to form a pruned convolution layer.

In another aspect of the application, a device for pruning a convolution layer in a neural network is provided. The device includes: a processor; and a memory, wherein the memory stores program instructions that are executable by the processor, and when executed by the processor, the program instructions cause the processor to perform: obtaining one target convolution layer from the one or more convolution layers in the neural network, the target convolution layer including C filters each including K convolution kernels, and each of the K convolution kernels including M rows and N columns of weight values, where C, K, M and N are positive integers greater than or equal to one; determining a number P of weight values to be pruned for each convolution kernel of the target convolution layer based on a number of weight values M×N in the convolution kernel and a target compression ratio, where P is a positive integer smaller than M×N; and setting P weight values with the smallest absolute values in each convolution kernel of the target convolution layer to zero to form a pruned convolution layer.

In another aspect of the application, a non-transitory computer-readable storage medium is provided. The non-transitory computer-readable storage medium has stored therein instructions that, when executed by a processor, cause the processor to perform a method for pruning one or more convolution layers in a neural network, the method including: obtaining one target convolution layer from the one or more convolution layers in the neural network, the target convolution layer including C filters each including K convolution kernels, and each of the K convolution kernels including M rows and N columns of weight values, where C, K, M and N are positive integers greater than or equal to one; determining a number P of weight values to be pruned for each convolution kernel of the target convolution layer based on a number of weight values M×N in the convolution kernel and a target compression ratio, where P is a positive integer smaller than M×N; and setting P weight values with the smallest absolute values in each convolution kernel of the target convolution layer to zero to form a pruned convolution layer.

In another aspect of the application, a device for pruning one or more convolution layers in a neural network is provided. The device includes an obtaining unit, a determining unit, and a pruning unit. The obtaining unit is configured for obtaining one target convolution layer from the one or more convolution layers in the neural network, the target convolution layer including C filters each including K convolution kernels, and each of the K convolution kernels including M rows and N columns of weight values, where C, K, M and N are positive integers greater than or equal to one. The determining unit is configured for determining a number P of weight values to be pruned for each convolution kernel of the target convolution layer based on a number of weight values M×N in the convolution kernel and a target compression ratio, where P is a positive integer smaller than M×N. The pruning unit is configured for setting P weight values with the smallest absolute values in each convolution kernel of the target convolution layer to zero to form a pruned convolution layer.

The foregoing is a summary of the present application and may be simplified, summarized, or omitted in detail, so that a person skilled in the art shall recognize that this section is merely illustrative and is not intended to limit the scope of the application in any way. This summary is neither intended to define key features or essential features of the claimed subject matter, nor intended to be used as an aid in determining the scope of the claimed subject matter.

### BRIEF DESCRIPTION OF THE DRAWINGS

The abovementioned and other features of the present application will be more fully understood from the following specification and the appended claims, taken in conjunction with the drawings. It can be understood that these drawings depict several embodiments of the present application and therefore should not be considered as limiting the scope of the present application. By applying the drawings, the present application will be described more clearly and in detail.

FIG. 1 illustrates a flowchart of a method for pruning a convolution layer in a neural network according to an embodiment of the present application;

FIG. 2 illustrates a schematic diagram of a neural network according to an embodiment of the present application;

FIG. 3(a) to FIG. 3(f) illustrate some exemplary convolution kernels in the convolution layer of the neural network illustrated in FIG. 2;

FIG. 4 illustrates a flowchart of a method for retraining a neural network with a pruned convolution layer according to an embodiment of the present application;

FIG. 5(a) and FIG. 5(b) illustrate schematic diagrams of performing a convolution operation using a retrained and updated convolution kernel according to an embodiment of the present application;

FIG. 6 illustrates a comparison between the method for pruning a convolution layer in a neural network according to an embodiment of the present application and the conventional pruning methods; and

FIG. 7 illustrates a block diagram of a device for pruning a convolution layer in a neural network according to an embodiment of the present application.

### DETAILED DESCRIPTION

The following detailed description refers to the drawings that form a part hereof. In the drawings, similar symbols generally identify similar components, unless context dictates otherwise. The illustrative embodiments described in the description, drawings, and claims are not intended to limit. Other embodiments may be utilized and other changes may be made without departing from the spirit or scope of the subject matter of the present application. It can be understood that numerous different configurations, alternatives, combinations and designs may be made to various aspects of the present application which are generally described and illustrated in the drawings in the application, and that all of which are expressly formed as part of the application.

A convolutional neural network (CNN), as one of the representative algorithms in deep learning, is a feedforward neural network with a multi-layer architecture. The CNN may include one or more convolution layers and corresponding pooling layers. The convolution layers may be used to extract features from input data, and generally, the more the convolution layers are, the more the features can be extracted, which then facilitate the generation of a more accurate output result. However, when a number of the convolution layers increases and a size of each convolution kernel becomes larger, not only the computational burden will increase, but also a bandwidth required for reading weight values of the convolution layers from an external memory for calculation in a batch mode will increase.

The inventors of the present application found that, in a CNN, the amount and complexity of computation mainly depend on the convolution layers with a large convolution kernel size (for example, a 3×3, 5×5, or 7×7 convolution kernel). However, there may be redundancy in these convolution kernels, that is, there may be weight values in the convolution kernels that contribute nothing or little to the accuracy of the output result. In view of this, if these redundant weight values can be pruned (for example, set to zero), the amount of computation of the neural network can be reduced, thereby reducing power consumption.

In view of the above, the present application provides a method for pruning a convolution layer in a neural network. In this method, a number P of weight values to be pruned is determined for each convolution kernel based on a number of weight values in the convolution kernel of the convolution layer and a target compression ratio, and then the P weight values with the smallest absolute values in each convolution kernel of the convolution layer are directly set to zero, so as to form a pruned convolution layer. The method of the present application does not perform sensitivity analysis on the convolution layer or convolution kernel when pruning the convolution kernel. That is, the method does not evaluate the influence of the pruned convolution layer or pruned convolution kernel on accuracy of outputs of the neural network, but directly prunes the same number of weight values with the smallest absolute values from all convolution kernels in the convolution layer. Therefore, the implementation of the method of the present application is simplified, and, since the pruning rules for each convolution kernel are the same, the complexity of a hardware circuit for implementing the method is also reduced.

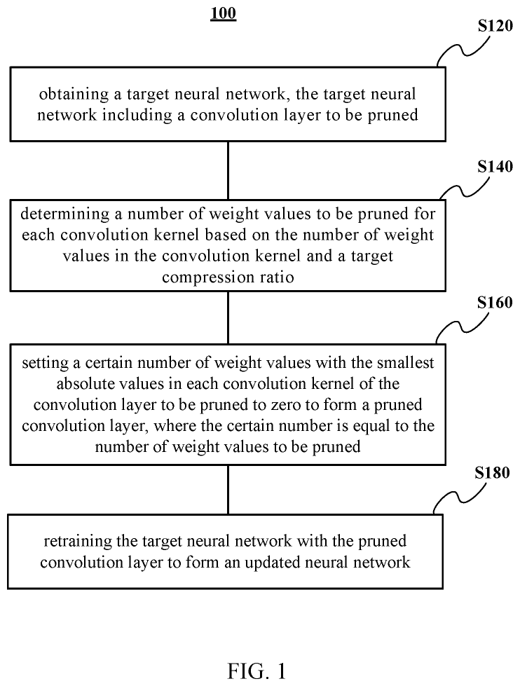

The method for pruning a convolution layer in the neural network of the present application will be described in detail below in conjunction with the drawings. FIG. 1 illustrates a flowchart of a method 100 for pruning a convolution layer in a neural network according to an embodiment of the present application, which specifically includes the following steps S120 to S180.

At step S120, a target neural network is obtained, where the target neural network includes a convolution layer to be pruned.

The target neural network may be a neural network obtained after being trained on a dataset of training samples. For example, the target neural network may be LeNet, AlexNet, VGGNet, GoogLeNet, ResNet or other types of CNN trained on CIFAR10, ImageNet or other types of datasets. In an example, the target neural network may be a ResNet56 CNN trained on the CIFAR10 dataset. It should be noted that, although the following embodiments take CNN as an example of the target neural network for description, it can be appreciated that the pruning method of the present application can be applied to any neural network that includes a convolution layer.

In some embodiments, the target neural network may include one or more convolution layers, and may also include a pooling layer, a full connection layer, or other layers. The method 100 shown in FIG. 1 can perform a pruning operation on one or more or all of the convolution layers in the target neural network according to actual needs. For simplicity, the following description takes pruning a single convolution layer to be pruned as an example, and assumes that the convolution layer to be pruned includes C filters, and each of the C filters includes K convolution kernels, each of the K convolution kernel includes M rows and N columns (M×N) weight values, where C, K, M, and N are positive integers greater than or equal to one. The convolution layer to be pruned is used to perform a convolution operation with outputs of K input channels of an input layer, and provides the operation results to C output channels of an output layer. It can be appreciated that the number of filters in the convolution layer is the same as the number of output channels in the output layer (i.e., C), and the number of convolution kernels in each filter is the same as the number of input channels in the input layer (i.e., K). Each filter performs a convolution operation (i.e., dot multiplication and addition operation) with all input channels of the input layer to obtain an output on a corresponding output channel of the output layer.

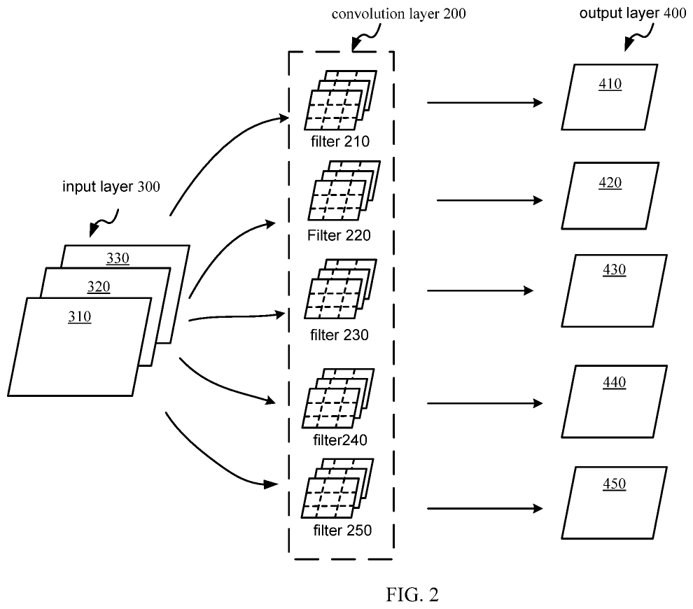

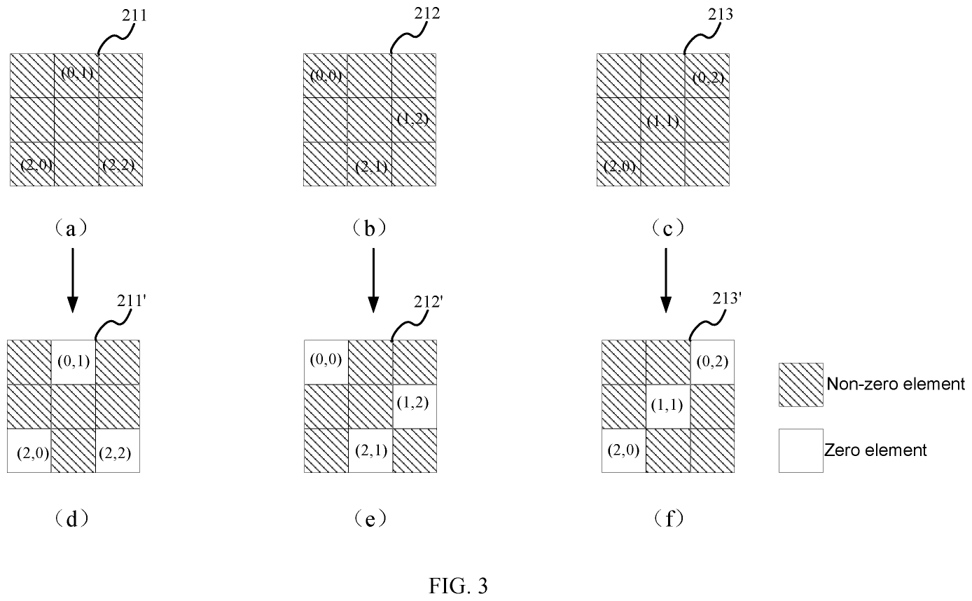

FIG. 2 illustrates a schematic diagram of a target neural network to which the method shown in FIG. 1 is applied. The target neural network includes an exemplary convolution layer 200. The convolution layer 200 is between an input layer 300 and an output layer 400 and is used to perform convolution operations with the data output by the input layer 300 to generate operation results, and the operation results are output via the output layer 400. In the example shown in FIG. 2, the convolution layer 200 includes five filters 210, 220, 230, 240 and 250, which respectively perform convolution operations with corresponding data output by the input layer 300, and the operation results will be output via five output channels 410, 420, 430, 440 and 450 of the output layer 400, respectively. Each of the filters 210, 220, 230, 240 and 250 may include 3 convolution kernels, and the 3 convolution kernels are used to perform convolution operations with the 3 input channels 310, 320 and 330 of the input layer 300, respectively. For example, the filter 210 includes three convolution kernels 211, 212 and 213 as shown in FIG. 3(a) to FIG. 3(c), and each convolution kernel includes 3 rows and 3 columns of weight values. In some exemplary applications for image processing or image recognition, the input layer 300 shown in FIG. 2 may be image data in RGB format, and the three input channels 310, 320 and 330 may be R, G and B color channels of the image data, respectively. After the convolution operations with the convolution layer 200, feature information of the image data in five dimensions can be obtained on the five output channels 410, 420, 430, 440 and 450 of the output layer 400, respectively. In other embodiments, the input layer may be voice data, text data, etc., depending on application scenarios of the CNN.

Referring to the examples shown in FIGS. 2 and 3, when the convolution layer 200 is used as the convolution layer to be pruned, the aforementioned values of C, K, M, and N may be 5, 3, 3 and 3, respectively. It can be appreciated that the convolution layers shown in FIG. 2 and FIG. 3 are only used as examples to describe the method of this application. In other embodiments, the parameters C, K, M and N of the convolution layer to be pruned can also be other different values.

At step S140, a number of weight values to be pruned is determined for each convolution kernel based on a number of weight values in the convolution kernel of the convolution layer to be pruned and a target compression ratio.

The target compression ratio may refer to a ratio of a number of non-zero weight values in the convolution layer after the pruning operation to a number of weight values in the convolution layer before the pruning operation, and is represented by R.

In some embodiments, the target compression ratio R of each convolution layer to be pruned may be preset based on an application scenario or a computation condition. For example, the target compression ratio R may be set according to an amount of computation or storage space that needs to be reduced in a specific application scenario or a specific computation condition. For example, the target compression ratio R is a value greater than zero and less than one, such as 4/5, 3/4, 2/3, 1/2, etc.

Still taking the convolution layer with the above parameters C, K, M, and N as an example, the number of weight values in each convolution kernel is M×N. Based on the number of weight values M×N in the convolution kernel and the target compression ratio R, a number P of weight values to be pruned can be determined for each convolution kernel. That is, the number of weight values M×N is multiplied by (1−R), and then a rounding operation is performed on the product M×N×(1−R) to obtain the number P of weight values to be pruned. In some embodiments, the rounding operation performed on the product M×N×(1−R) includes rounding the product to the nearest integer. In some embodiments, in order to ensure that the target compression ratio can be achieved after the pruning operation, the product M×N×(1−R) is rounded up in the rounding operation. It can be appreciated that, in some embodiments, a rounding down operation or other kinds of rounding operations can also be adopted according to different application scenarios. Since the value of the target compression ratio R is greater than zero and less than one, P is a positive integer less than M×N.

It can be understood that the neural network may include multiple convolution layers, and the number of weight values of convolution kernels in different convolution layers may be the same or different. For example, different convolution layers may include different convolution kernels of 3×3, 3×5, 5×5, 5×7 or 7×7, and accordingly, the numbers of weight values included in these different convolution kernel are 9, 15, 25, 35 or 49, respectively. Taking the target compression ratio set to 2/3 as an example, for a 3×3 convolution kernel, the number of weight values to be pruned is (3×3)×(1−2/3)=3, and a number of remaining weight values is 6; for a 5×5 convolution kernel, the number of weight values to be pruned is an integer obtained by rounding up (5×5)×(1−2/3) (i.e., 9), and a number of remaining non-zero weight values is 16; and, for a 7×7 convolution kernel, the number of weight values to be pruned is an integer obtained by rounding up (7×7)×(1−2/3) (i.e., 17), and the number of remaining non-zero weight values is 32.

At step S160, a certain number of weight values with the smallest absolute values in each convolution kernel of the convolution layer to be pruned are set to zero to form a pruned convolution layer, where the certain number is equal to the number of weight values to be pruned.

The above convolution layer with the parameters C, K, M, and N is further taken as an example to illustrate the pruning operation described below.

In some embodiments, first, all the weight values of the convolution layer to be pruned is expanded to a two-dimensional matrix with C×K rows and M×N columns; then, the M×N weight values in each row of the two-dimensional matrix are ranked according to their respective absolute values; then, the P weight values with the smallest absolute values among the M×N weight values in each row are set to zero; and then, the two-dimensional matrix is rearranged to obtain the pruned convolution layer, where the pruned convolution layer includes C filters corresponding to the convolution layer to be pruned, each of the C filters includes K convolution kernels, and each of the K convolution kernels includes M rows and N columns of weight values. It can be appreciated that the positions of the weight value not set to zero in the pruned convolution layer are the same as their positions in the convolution layer to be pruned. In some other embodiments, instead of performing the above matrix expansion operation, the C×K convolution kernels in the convolution layer to be pruned are processed in sequence, that is, the P weight values with the smallest absolute values in each convolution kernel are set to zero in sequence, so as to form a respective convolution kernel of the pruned convolution layer.

It should be noted that, in the pruning method of the embodiments of the present application, the number of weight values set to zero in each convolution kernel in the convolution layer to be pruned is the same, that is, the number of weight values to be pruned for each convolution kernel is P. Compared with a conventional pruning method in which the convolution kernels may have different numbers of weight values set to zero, the solution of the present application can be easily implemented by a hardware circuit.

FIGS. 3(a) to 3(f) illustrate a process for pruning the filter 210 in the convolution layer to be pruned 200 in FIG. 2 with a compression ratio of 2/3. It can be seen that, three weight values with the smallest absolute values at positions (0, 1), (2, 0) and (2, 2) of the convolution kernel 211 in FIG. 3(a) are set to zero, so as to from the pruned convolution kernel 211′ in FIG. 3(d); three weight values with the smallest absolute values at positions (0, 0), (1, 2) and (2, 1) of the convolution kernel 212 in FIG. 3(b) are set to zero, so as to form the pruned convolution kernel 212′ in FIG. 3(e); and, three weight values with the smallest absolute values at positions (0, 2), (1, 1) and (2, 0) of the convolution kernel 213 in FIG. 3(c) are set to zero, so as to form the pruned convolution kernel 213′ in FIG. 3(f).

In some embodiments, after performing step S160, the pruning operation for a convolution layer in the target neural network is completed. As the pruned convolution layer has fewer non-zero weight values, an amount of computation for the convolution operations performed based on the pruned convolution layer can be reduced.

In the embodiment shown in FIG. 1, after step S160, subsequent process may be performed to retrain the target neural network, especially to improve its accuracy.

At step S180, the target neural network with the pruned convolution layer is retrained to form an updated neural network. The updated neural network includes an updated convolution layer generated by retraining the pruned convolution layer, and weight values of the updated convolution layer at positions corresponding to positions of the weight values set to zero in the pruned convolution layer are zero.

In some embodiments, the target neural network with the pruned convolution layer may be retrained by using the dataset of training samples which is the same as that used for training the target neural network, such as CIFAR10, ImageNet or other types of datasets. In some other embodiments, the target neural network with the pruned convolution layer may be retrained by using a dataset of training samples different from that used for training the target neural network. A reason for performing the retraining operation in step S180 is that, although pruning the convolution layer in the target neural network can effectively reduce the parameters and the amount of computation for the convolution layer, the accuracy of the target neural network with the pruned convolution layer may usually decrease as some weight values in the original convolution layer have been pruned. Therefore, the target neural network with the pruned convolution layer may be retrained, and the non-zero weight values of the pruned convolution layer can be fine-tuned and updated to reduce the loss of accuracy.

However, it should be noted that, in some embodiments, during the retraining of the target neural network with the pruned convolution layer, only the non-zero weight values of the pruned convolution layer are needed to be updated, and it may be avoided to update the weight values set to zero in the pruning operation to non-zero values. In some other embodiments, retraining the target neural network with the pruned convolution layer may also update a part of the weight values set to zero to non-zero values. However, it is preferable that, for the consideration of reducing the amount of computation, none of the weight values set to zero in the pruning operation is updated to a non-zero value in the retraining operation. Correspondingly, in some embodiments, a mask tensor is generated, and each element in the mask tensor corresponds to a respective weight value in the pruned convolution layer. The elements of the mask tensor at positions corresponding to the positions of the weight values set to zero in the pruned convolution layer are zero, and the elements of the mask tensor at other positions are one. In the process of retraining the target neural network with the pruned convolution layer to form the updated neural network, the mask tensor is used to set gradient values of an error gradient tensor at positions corresponding to the positions of the weight values set to zero in the pruned convolution layer to zero, so as to set the weight values of the updated convolution layer at the positions corresponding to the positions of the weight values set to zero in the pruned convolution layer to zero.

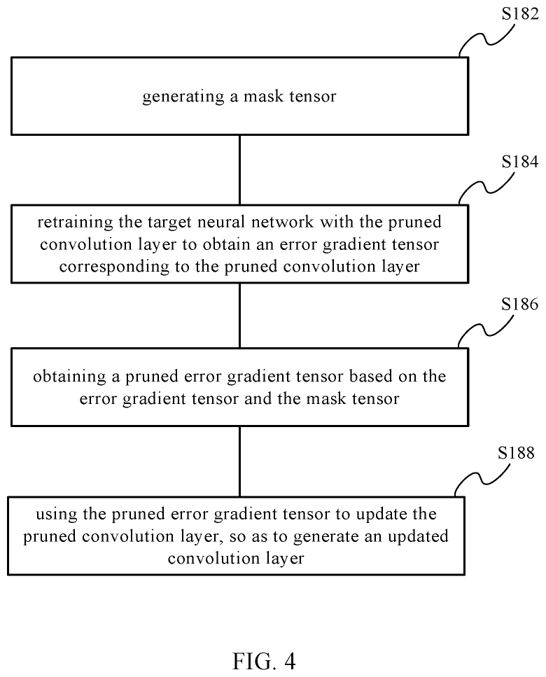

FIG. 4 illustrates a process of retraining the target neural network with the pruned convolution layer to form the updated neural network according to an embodiment of the present application. The process includes the following steps.

At step S182, a mask tensor is generated.

Specifically, a mask tensor mask is generated, where the mask tensor mask has a size corresponding to the size of the pruned convolution layer, and each element in the mask tensor mask corresponds to a respective weight value in the pruned convolution layer. For example, the mask tensor mask also has four dimensions of C, K, M, and N. Then, the mask tensor mask is initialized so that elements of the mask tensor at positions corresponding to the positions of the weight values set to zero in the pruned convolution layer are zero, and elements of the mask tensor at other positions are one.

At step S184, the target neural network with the pruned convolution layer is retrained to obtain an error gradient tensor corresponding to the pruned convolution layer.

In some embodiments, the retraining operation includes forward propagation of the target neural network with the pruned convolution layer on a dataset of training samples. The forward propagation may include: inputting input data of the dataset of training samples to the target neural network with the pruned convolution layer for convolution operations, and obtaining an output result of the pruned convolution layer according to the input data. Then, the above output result is compared with a standard output result obtained by performing convolution operations on the convolution layer to be pruned in the original unpruned target neural network using the same input data, and the difference between the two results can be used as the error gradient tensor gradient of the pruned convolution layer.

At step S186, a pruned error gradient tensor is obtained based on the error gradient tensor and the mask tensor.

In some embodiments, a Hadamard multiplication operation is performed on the error gradient tensor gradient and the mask tensor mask (that is, corresponding elements of gradient and mask are multiplied) to obtain the pruned error gradient tensor gradient′. Similar to the mask tensor mask, elements of the pruned error gradient tensor gradient′ at positions corresponding to the positions of the weight values set to zero in the pruned convolution layer are zero.

At step S188, the pruned error gradient tensor is used to update the pruned convolution layer, so as to generate an updated convolution layer.

In some embodiments, a back propagation algorithm is used. Based on the pruned error gradient tensor gradient′, changes in weight values of the convolution layers can be obtained through back propagation of the target neural network, and then, the changes can be used to update the pruned convolution layer, so as to reduce a difference between an output result of the updated convolution layer and the standard output result. Specifically, a gradient update operation can be performed on the pruned convolution layer according to the following Equation (1) to obtain the updated convolution layer:

w′=w+λ*(gradient o mask) Equation (1).

In Equation (1), w′ represents the updated convolution layer, w represents the pruned convolution layer, λ, represents a learning rate, gradient represents the error gradient tensor, mask represents the mask tensor, and “o” represents the Hadamard operator (i.e., multiplying corresponding elements of two tensors), and (gradient o mask) represents the pruned error gradient tensor gradient′.

By retraining the target neural network with the pruned convolution layer, each time the error is back propagated to update the pruned convolution layer, the Hadamard multiplication operation is performed on the error gradient tensor and the mask tensor to obtain the pruned error gradient tensor, which is used to update the pruned convolution layer. As the elements of the pruned error gradient tensor at positions corresponding to the positions of the weight values set to zero in the pruned convolution layer are zero, it is ensured that the pruned weight value is always zero during the entire update process.

In some embodiments, steps S182 to S188 may be iteratively performed until the error gradient tensor reaches a small value. For example, an error gradient threshold can be preset, and, after obtained in step S184, the error gradient tensor may be compared with the error gradient threshold. If the error gradient tensor is greater than the error gradient threshold, the subsequent step S186 continues to be performed. If the error gradient tensor is less than the error gradient threshold, the retraining process ends. After the end of the retraining process, the latest convolution layer is used as the updated convolution layer.

It should be noted that, in the foregoing step S140, an embodiment in which the target compression ratio is preset based on a specific application scenario is described. In some other embodiments, the target compression ratio may also be set based on a target accuracy. For example, the target compression ratio may be set such that an accuracy of the updated neural network is greater than or equal to the target accuracy when neural network operations are performed. The target accuracy refers to an acceptable accuracy threshold of the neural network after the convolution layer in the neural network has been pruned and the accuracy has been reduced. Generally, the lower the target compression ratio is, the more the weight values to be pruned are, and the greater the loss of accuracy of the neural network is. Therefore, it is desired to make a tradeoff between the target compression ratio and the target accuracy, so as to prune as many weight values as possible while ensuring that the target accuracy under the current application scenario is met. Accordingly, in some embodiments, the target compression ratio can be adjusted according to the target accuracy. Specifically, an updated accuracy of the updated neural network can be obtained by performing neural network operations, and then the updated accuracy may be compared with the target accuracy. If the updated accuracy is less than the target accuracy, the target compression ratio should be increased, the number of weight values to be pruned is re-determined based on the increased target compression ratio, and the above steps S140 to S180 are iteratively performed until the updated accuracy is greater than or equal to the target accuracy. On the other hand, after comparing the updated accuracy with the target accuracy data, if the updated accuracy is greater than the target accuracy data, the target compression ratio can be decreased and the number of weight values to be pruned can be re-determined based on the reduced target compression ratio, so as to prune as many weight values as possible.

It should also be noted that, although the technical solution of the application is described in the above embodiments by pruning a single convolution layer to be pruned in the target neural network, it is only for the purpose of illustration. It can be appreciated that the technical solution of the application may be used to prune more than one or all of the convolution layers in the target neural network. For example, in a case that more than one convolution layer in the neural network needs to be pruned, the above convolution layer 200 is determined as one target convolution layer and is pruned via the method illustrated in FIG. 1, then another target convolution layer is obtained from the more than one convolution layer in the neural network and is also pruned by the method illustrated via FIG. 1, and so on until all of the more than one convolution layer are pruned. Specifically, the another target convolution layer may include C′ filters each including K′ convolution kernels, and each of the K′ convolution kernels may include M′ rows and N′ columns of weight values, where C′, K′, M′ and N′ are positive integers greater than or equal to one. A number P′ of weight values to be pruned for each convolution kernel of the another target convolution layer is determined based on a number of weight values M′×N′ in the convolution kernel and another target compression ratio, where P′ is a positive integer smaller than M′×N′. Then, P′ weight values with the smallest absolute values in each convolution kernel of the another target convolution layer are set to zero to form another pruned convolution layer. The parameters of the another target convolution layer may be the same as the parameters of the target convolution layer 200 (i.e., C′, K′, M′ and N′ equal to C, K, M and N, respectively), or may be different from the parameters of the target convolution layer 200 (i.e., at least one of C′, K′, M′ and N′ does not equal to the respective one of C, K, M and N). In the above example, the target convolution layer 200 and the another target convolution layer are pruned sequentially. In another example, the target convolution layer 200 and the another target convolution layer may be pruned simultaneously.

In addition, as the scale and depth of the CNN increases, it usually contains a lot of convolution layers, each of which may have a different number of filters, a different size of convolution kernel, and a different position in the CNN. In order to reduce the compression ratio of the entire target neural network as much as possible and ensure a high accuracy, different target compression ratios can be set for different convolution layers in the target neural network. For example, in a CNN, a redundancy of the convolution layer at the front-end is usually smaller, and the redundancy of the convolution layer at the back-end is usually higher. Therefore, a lower target compression ratio may be set for the convolution layer at the back-end, and a higher target compression ratio may be set for the convolution layer at the front-end.

In some embodiments, after obtaining the updated convolution layer, the neural network with the updated convolution layer needs to be stored for use in subsequent operations. As the pruning operation has been performed thereon, the updated convolution layer includes a large number of weight value matrices with high sparseness. Therefore, the updated convolution layer can be stored after compression to reduce the storage space required. When the neural network needs to be used for specific computations, the stored updated convolution layer can be directly read out and rearranged for use in a static configuration. Otherwise, in a dynamic configuration (for example, a deformable network), a transformation operation (for example, offset, rotation, etc.) should be performed on the stored updated convolution layer, and then the transformed convolution layer is used in subsequent operations. During usage, since a large number of weight values in the convolution layer have been set to zero, the bandwidth required for reading the weight values from an external memory can be reduced, and the operation efficiency can be improved as the number of non-zero weight values involved in the calculation is reduced. Further, it can be appreciated that the storage and reading of the convolution layer can be implemented in various suitable ways.

For example, the convolution operation using the convolution layer to be pruned before the pruning operation can be described by Equation (2):

y[i,j,c]=ΣₖΣ_{(m,n)∈Ω(ω)}2[m,n,k,c]×[i+m,j+n,k] Equation (2)

In Equation (2), the convolution layer is represented by a four-dimensional tensor w[m, n, k, c], where c is an index of a filter in the convolution layer, k is an index of a convolution kernel in each filter, and m and n are indexes of a row and a column of a weight value in each convolution kernel. y[i,j,c] represents elements of the output layer, and [i+m,j+n,k] represents elements of the input layer. When the convolution kernel is a 3×3 matrix and each weight value is not zero, non-zero elements in the set Q{ω} are ω={(0, 0), (0, 1), (0, 2) , (1, 0), (1, 1), (1, 2), (2, 0), (2, 1), (2, 2)}.

Correspondingly, the convolution operation using the updated convolution layer after the pruning operation can be described by Equation (3):

y[i,j,c]=ΣₖΣ_{(m,n)∈Ω(ω′)}w[m,n,k,c]×[i+m,j+n,k] Equation (3).

The same symbols in Equation (3) and Equation (2) represent the same factors. However, in the updated convolution layer, because a large number of weight values have been set to zero based on the target compression ratio, the number of non-zero elements in the set Ω(ω′) is greatly reduced, so that the computation amount in the convolution operations can be greatly reduced.

The filter 210 is taken as an example to illustrate the pruning operation in the following description. FIG. 3(a), FIG. 3(b), and FIG. 3(c) represent the element patterns of the convolution kernels 211, 212 and 213 in the filter 210 before the pruning operation, and FIG. 3(d), FIG. 3(e) and FIG. 3(f) represent the element patterns of the corresponding convolution kernels 211′, 212′, and 213′ in the pruned filter 210, where the shaded boxes represent non-zero elements and the blank boxes represent zero elements. It can be seen that, each of the convolution kernels 211, 212 and 213 before the pruning operation includes non-zero elements: ω={(0, 0), (0, 1), (0, 2), (1, 0), (1, 1), (1, 2), (2, 0), (2, 1), (2, 2)}; but after the pruning operation, the corresponding convolution kernels 211′, 212′ and 213′ respectively include non-zero elements as below:
ω211′={(0, 0), (0, 2), (1, 0), (1, 1), (1, 2), (2, 1)};
ω212′={(0, 1), (0, 2), (1, 0), (1, 1), (2, 0), (2, 2)};
ω213′={(0, 0), (0, 1), (1, 0), (1, 2), (2, 1), (2, 2)}.

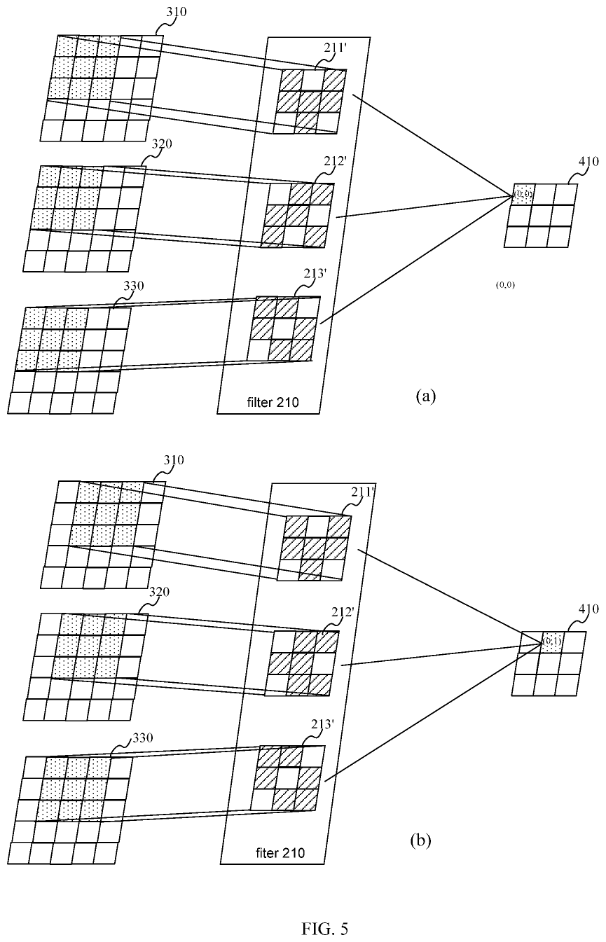

It can be seen that, after the pruning operation, a number of non-zero elements in each convolution kernel is reduced from 9 to 6, which can greatly reduce the amount of computation of the convolution operations. Refer to FIGS. 5(a) to 5(b), a schematic diagram of using the pruned convolution kernels 211′, 212′ and 213′ to calculate elements at positions of (0, 0) and (0, 1) of the first output channel 410 is illustrated. Specifically, as shown in FIG. 5(a), dot products of the three 3×3 convolution kernels 211′, 212′ and 213′ in the pruned filter 210 and three 3×3 matrices in the upper left corner of the 3 input channels 310, 320 and 330 of the input layer 300 are respectively calculated and then summed, so as to obtain an element at (0, 0) of the first output channel 410 of the output layer. Then, as shown in FIG. 5(b), the value-selecting box of the input layer 300 “slides” one grid rightward, and dot products of three 3×3 matrices starting from the second column of the 3 input channels 310, 320 and 330 of the input layer 300 and the three convolution kernels 211′, 212′ and 213′ are respectively calculated and then summed, so as to obtain an element at (0, 1) of the first output channel 410 of the output layer. Continuing to “slide” the value-selecting box of the input layer 300 rightward and downward, data matrixes of the 3 input channels of the input layer 300 are selected for calculation with the three convolution kernels, so as to obtain elements at other positions of the first output channel 410. The details are not be elaborated herein.

Referring to FIG. 6, the accuracies of the method for pruning the convolution layer in the neural network of the present application and the conventional Filter_wise and Kernel_wise pruning methods are compared with each other, using a ResNet56 CNN obtained through training on the CIFAR10 dataset. In the Filter_wise or Kernel_wise pruning methods, sensitivity analysis may be performed on each convolution layer before the pruning operation. That is, each convolution layer of the neural network is independently pruned filter-by-filter or convolution kernel-by-convolution kernel, and then an accuracy of the pruned neural network is evaluated based on a dataset of testing samples. The more the accuracy decreases, the more sensitive the convolution layer is. Then, a pruning ratio is set for the filters or the convolution kernels in each convolution layer according to the sensitivity, and, after that, the entire network is retrained. In contrast, the method for pruning the convolution layer in the neural network of the present application does not perform sensitivity analysis, but only needs to set the number of weight values to be pruned for all convolution kernels, and then the number of weight values are directly pruned from each convolution kernel, thereby simplifying the pruning process. Furthermore, it can be seen from FIG. 6 that, under different sparsity conditions (sparseness=1−compression ratio, for example, a sparseness of 90% corresponds to a compression ratio of 10%), the accuracy of the pruning method of the present application is higher than accuracies of both of the Filter_wise and the Kernel_wise pruning methods. In other words, with the same accuracy, the pruning method of the present application can prune more weight values, and achieve a higher performance.

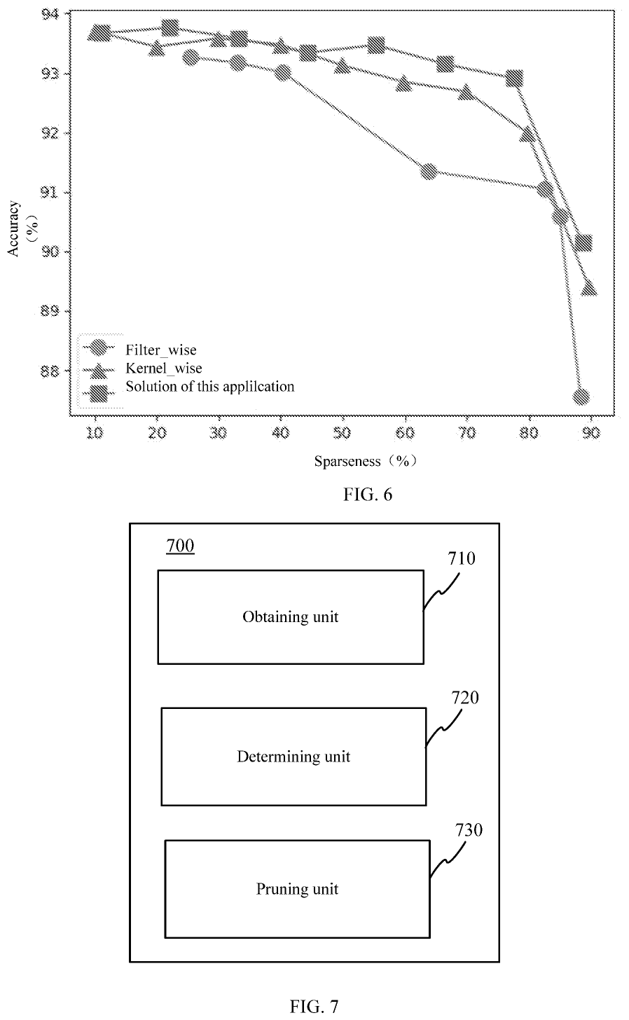

Embodiments of the present application also provide a device for pruning a convolution layer in a neural network. As shown in FIG. 7, a device 700 for pruning a convolution layer in a neural network includes an obtaining unit 710, a determining unit 720, and a pruning unit 730. The obtaining unit 710 is configured for obtaining a target neural network, where the target neural network includes a convolution layer to be pruned, each convolution layer to be pruned includes C filters, each of the C filters includes K convolution kernels, and each of the K convolution kernels includes M rows and N columns of weight values, and C, K, M and N are positive integers greater than or equal to one. The determining unit 720 is configured for determining a number P of weight values to be pruned for each convolution kernel based on a number of weight values M×N in the convolution kernel and a target compression ratio, where P is a positive integer smaller than M×N. The pruning unit 730 is configured for setting P weight values with the smallest absolute values in each convolution kernel of the convolution layer to be pruned to zero to form a pruned convolution layer. More detailed descriptions of the device 700 may refer to the above description of the corresponding method in conjunction with FIGS. 1 to 6, and are not be elaborated herein.

In some embodiments, the device 700 for pruning the convolution layers in the neural network may be implemented as one or more of an application-specific integrated circuits (ASIC), a digital signal processor (DSP), a digital signal processing device (DSPD), a programmable logic device (PLD), a field programmable gate array (FPGA), a controller, a microcontroller, a microprocessor or other electronic components. In addition, the device embodiments described above are only for the purpose of illustration. For example, the division of the units is only a logical function division, and there may be other divisions in actual implementations. For example, multiple units or components may be combined or may be integrate into another system, or some features can be omitted or not implemented. In addition, the displayed or discussed mutual coupling, direct coupling or communication connection may be indirect coupling or indirect communication connection through some interfaces, devices or units in electrical or other forms. The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments.

In other embodiments, the device 700 for pruning the convolution layer in the neural network can also be implemented in the form of a software functional unit. If the functional unit is implemented in the form of a software functional unit and sold or used as an independent product, it can be stored in a computer readable storage medium and can be executed by a computer device. Based on this understanding, the essential of the technical solution of this application, or the part that contributes to the conventional technology, or all or part of the technical solution, can be embodied in the form of a software product, which is stored in a storage medium. The software product may include a number of instructions to enable a computer device (for example, a personal computer, a mobile terminal, a server, or a network device, etc.) to perform all or part of steps of the method in each embodiment of the present application.

Embodiments of the present application also provides an electronic device, which includes a processor and a storage device. The storage device is configured to store a computer program that can run on the processor. When the computer program is executed by the processor, the processor is caused to execute the method for pruning the convolution layer in the neural network in the foregoing embodiments. In some embodiments, the electronic device may be a mobile terminal, a personal computer, a tablet computer, a server, etc.

Embodiments of the present application also provide a non-transitory computer-readable storage medium, the non-transitory computer-readable storage medium stores a computer program, and when the computer program is executed by a processor, the method for pruning a convolution layer in a neural network is performed. In some embodiments, the non-transitory computer-readable storage medium may be a flash memory, a read only memory (ROM), an electrically programmable ROM, an electrically erasable and programmable ROM, register, hard disk, removable disk, CD-ROM, or any other form of non-transitory computer-readable storage medium known in the art.

Those skilled in the art will be able to understand and implement other changes to the disclosed embodiments by studying the specification, disclosure, drawings and appended claims. In the claims, the wordings “comprise”, “comprising”, “include” and “including” do not exclude other elements and steps, and the wordings “a” and “an” do not exclude the plural. In the practical application of the present application, one component may perform the functions of a plurality of technical features cited in the claims. Any reference numeral in the claims should not be construed as limit to the scope.

What is claimed is:

1. A method for pruning one or more convolution layers in a neural network, comprising:
obtaining one target convolution layer from the one or more convolution layers in the neural network, the target convolution layer comprising C filters each comprising K convolution kernels, and each of the K convolution kernels comprising M rows and N columns of weight values, where C, K, M and N are positive integers greater than or equal to one;
determining a number P of weight values to be pruned for each convolution kernel of the target convolution layer based on a number of weight values M×N in the convolution kernel and a target compression ratio, where P is a positive integer smaller than M×N; and
setting P weight values with the smallest absolute values in each convolution kernel of the target convolution layer to zero to form a pruned convolution layer.

2. The method of claim 1, further comprising:
retraining the target neural network with the pruned convolution layer to form an updated neural network, wherein the updated neural network comprises an updated convolution layer generated by retraining the pruned convolution layer, and weight values of the updated convolution layer at positions corresponding to positions of the weight values set to zero in the pruned convolution layer are zero.

3. The method of claim 2, wherein retraining the target neural network with the pruned convolution layer to form an updated neural network comprises:
generating a mask tensor, wherein each element in the mask tensor corresponds to a respective weight value in the pruned convolution layer, elements of the mask tensor at positions corresponding to the positions of the weight values set to zero in the pruned convolution layer are zero, and elements of the mask tensor at other positions are one; and
setting gradient values of an error gradient tensor at positions corresponding to the positions of the weight values set to zero in the pruned convolution layer to zero by using the mask tensor, so as to set the weight values of the updated convolution layer at the positions corresponding to positions of the weight values set to zero in the pruned convolution layer to zero.

4. The method of claim 3, wherein setting gradient values of an error gradient tensor at positions corresponding to the positions of the weight values set to zero in the pruned convolution layer to zero by using the mask tensor comprises:
performing a Hadamard multiplication operation on the mask tensor and the error gradient tensor.

5. The method of claim 2, wherein the target compression ratio is set based on a target accuracy, and the target compression ratio enables the updated neural network to perform a neural network operation with an accuracy greater than or equal to the target accuracy.

6. The method of claim 5, further comprising:
obtaining an updated accuracy of a neural network operation performed by the updated neural network;
comparing the updated accuracy with the target accuracy; and
increasing the target compression ratio and re-determining the number P of weight values to be pruned based on the increased target compression ratio, in response to that the updated accuracy is less than the target accuracy.

7. The method of claim 1, wherein setting P weight values with the smallest absolute values in each convolution kernel of the target convolution layer to zero comprises:
expanding all the weight values of the target convolution layer into a two-dimensional matrix with C×K rows and M×N columns;
ranking the M×N weight values in each row of the two-dimensional matrix according to their respective absolute values;
setting the P weight values with the smallest absolute values among the M×N weight values in each row to zero; and
rearranging the two-dimensional matrix to obtain the pruned convolution layer, wherein the pruned convolution layer comprises C filters corresponding to the target convolution layer, each of the C filters comprises K convolution kernels, and each of the K convolution kernels comprises M rows and N columns of weight values.

8. The method of claim 2, wherein the target convolution layer or the updated convolution layer is used to perform a convolution operation with K input channels of an input layer, so as to generate C operation results to be output via C output channels of an output layer.

9. The method of claim 1, wherein the neural network is a convolutional neural network (CNN).

10. The method of claim 1, wherein, when the method is used to prune more than one convolution layer in the neural network, the method further comprises:
obtaining another target convolution layer from the more than one convolution layer in the neural network, the another target convolution layer comprising C′ filters each comprising K′ convolution kernels, and each of the K′ convolution kernels comprising M′ rows and N′ columns of weight values, where C′, K′, M′ and N′ are positive integers greater than or equal to one;
determining a number P′ of weight values to be pruned for each convolution kernel of the another target convolution layer based on a number of weight values M′×N′ in the convolution kernel and another target compression ratio, where P′ is a positive integer smaller than M′×N′; and
setting P′ weight values with the smallest absolute values in each convolution kernel of the another target convolution layer to zero to form another pruned convolution layer.

11. A device for pruning one or more convolution layers in a neural network, comprising:
a processor; and
a memory, wherein the memory stores program instructions that are executable by the processor, and when executed by the processor, the program instructions cause the processor to perform:
obtaining one target convolution layer from the one or more convolution layers in the neural network, the target convolution layer comprising C filters each comprising K convolution kernels, and each of the K convolution kernels comprising M rows and N columns of weight values, where C, K, M and N are positive integers greater than or equal to one;
determining a number P of weight values to be pruned for each convolution kernel of the target convolution layer based on a number of weight values M×N in the convolution kernel and a target compression ratio, where P is a positive integer smaller than M×N; and
setting P weight values with the smallest absolute values in each convolution kernel of the target convolution layer to zero to form a pruned convolution layer.

12. The device of claim 11, wherein when executed by the processor, the program instructions further cause the processor to perform:
retraining the target neural network with the pruned convolution layer to form an updated neural network, wherein the updated neural network comprises an updated convolution layer generated by retraining the pruned convolution layer, and weight values of the updated convolution layer at positions corresponding to positions of the weight values set to zero in the pruned convolution layer are zero.

13. The device of claim 12, wherein retraining the target neural network with the pruned convolution layer to form an updated neural network comprises:
generating a mask tensor, wherein each element in the mask tensor corresponds to a respective weight value in the pruned convolution layer, elements of the mask tensor at positions corresponding to the positions of the weight values set to zero in the pruned convolution layer are zero, and elements of the mask tensor at other positions are one; and
setting gradient values of an error gradient tensor at positions corresponding to the positions of the weight values set to zero in the pruned convolution layer to zero by using the mask tensor, so as to set the weight values of the updated convolution layer at the positions corresponding to positions of the weight values set to zero in the pruned convolution layer to zero.

14. The device of claim 13, wherein setting gradient values of an error gradient tensor at positions corresponding to the positions of the weight values set to zero in the pruned convolution layer to zero by using the mask tensor comprises:
performing a Hadamard multiplication operation on the mask tensor and the error gradient tensor.

15. The device of claim 12, wherein the target compression ratio is set based on a target accuracy, and the target compression ratio enables the updated neural network to perform a neural network operation with an accuracy greater than or equal to the target accuracy.

16. The device of claim 15, wherein when executed by the processor, the program instructions further cause the processor to perform:
obtaining an updated accuracy of a neural network operation performed by the updated neural network;
comparing the updated accuracy with the target accuracy; and
increasing the target compression ratio and re-determining the number P of weight values to be pruned based on the increased target compression ratio, in response to that the updated accuracy is less than the target accuracy.

17. The device of claim 11, wherein setting P weight values with the smallest absolute values in each convolution kernel of the target convolution layer to zero comprises:
expanding all the weight values of the target convolution layer into a two-dimensional matrix with C×K rows and M×N columns;
ranking the M×N weight values in each row of the two-dimensional matrix according to their respective absolute values;
setting the P weight values with the smallest absolute values among the M×N weight values in each row to zero; and
rearranging the two-dimensional matrix to obtain the pruned convolution layer, wherein the pruned convolution layer comprises C filters corresponding to the target convolution layer, each of the C filters comprises K convolution kernels, and each of the K convolution kernels comprises M rows and N columns of weight values.

18. The device of claim 12, wherein the target convolution layer or the updated convolution layer is used to perform a convolution operation with K input channels of an input layer, so as to generate C operation results to be output via C output channels of an output layer.

19. The device of claim 10, wherein, when the device is used to prune more than one convolution layer in the neural network, the program instructions further cause the processor to perform:
obtaining another target convolution layer from the more than one convolution layer in the neural network, the another target convolution layer comprising C′ filters each comprising K′ convolution kernels, and each of the K′ convolution kernels comprising M′ rows and N′ columns of weight values, where C′, K′, M′ and N′ are positive integers greater than or equal to one;
determining a number P′ of weight values to be pruned for each convolution kernel of the another target convolution layer based on a number of weight values M′×N′ in the convolution kernel and another target compression ratio, where P′ is a positive integer smaller than M′×N′; and
setting P′ weight values with the smallest absolute values in each convolution kernel of the another target convolution layer to zero to form another pruned convolution layer.

20. A non-transitory computer-readable storage medium having stored therein instructions that, when executed by a processor, cause the processor to perform a method for pruning one or more convolution layers in a neural network, the method comprising:
obtaining one target convolution layer from the one or more convolution layers in the neural network, the target convolution layer comprising C filters each comprising K convolution kernels, and each of the K convolution kernels comprising M rows and N columns of weight values, where C, K, M and N are positive integers greater than or equal to one;
determining a number P of weight values to be pruned for each convolution kernel of the target convolution layer based on a number of weight values M×N in the convolution kernel and a target compression ratio, where P is a positive integer smaller than M×N; and
setting P weight values with the smallest absolute values in each convolution kernel of the target convolution layer to zero to form a pruned convolution layer.
